(19) United States
(12) Patent Application Publication
(10) Pub. No.: US 2013/0025117 A1
(43) Pub. Date: Jan. 31, 2013

(54) METHOD FOR MANUFACTURING A ROTATING DEVICE

(71) Applicants: Kenji NISHIHARA, Shizuoka (JP); Masayuki ISHIKAWA, Shizuoka (JP)

(72) Inventors: Kenji NISHIHARA, Shizuoka (JP); Masayuki ISHIKAWA, Shizuoka (JP)

(73) Assignee: ALPHANA TECHNOLOGY CO., LTD., Shizuoka (JP)

(21) Appl. No.: 13/533,669

(22) Filed: Jun. 26, 2012

(30) Foreign Application Priority Data
Jul. 27, 2011 (JP) 2011-163919

(51) Int. Cl. G11B 5/127

(52) U.S. Cl. 29/603.04

(57) ABSTRACT

A rotating device comprises a hub on which a magnetic recording disk is to be mounted and a base rotatably supporting the hub. At least one of the base and the hub is an item of manufacture. A method for manufacturing the rotating device comprises the steps of forming the item of manufacture, immersing the formed item of manufacture in an aqueous solution, the solute of which being a surfactant and the temperature of which being higher than the melting point of heptacosane, taking out the item of manufacture from the aqueous solution and immersing the item of manufacture in a liquid that can be regarded as pure water, taking out the item of manufacture from the liquid and drying the item of manufacture, and assembling the rotating device using the dried item of manufacture.

### CROSS-REFERENCE TO RELATED APPLICATIONS

This application is based upon and claims the benefit of priority from the prior Japanese Patent Application No. 2011-163919, filed on Jul. 27, 2011, the entire contents of which are incorporated herein by reference.

### BACKGROUND OF THE INVENTION

1. Field of the Invention

The present invention relates to a method for manufacturing a rotating device.

2. Description of the Related Art

Disk drive devices, such as hard disk drives, have become miniaturized and the capacity of a disk drive device has steadily increased. Such disk drive devices have been installed in various types of electronic devices, in particular, portable electronic devices such as laptop computers and portable music players. In the related art, a disk drive device has been proposed as described, for example, in Japanese Patent Application Publication No. 2007-198555.

### SUMMARY OF THE INVENTION

In general, there is a small amount of carbon hydride, such as grease, that adheres to a magnetic recording disk just after a disk drive device has been manufactured. However, over time, grease adhering to other parts of the disk drive device can migrate to the surface of the magnetic recording disk through a scatter process or an evaporation-recondensation process.

If grease enters into the gap between the magnetic head and the magnetic recording disk while the disk drive device is being used, the natural motion of the magnetic head can be disrupted, or errors may occur when reading the magnetic recording disk. As such, the error rate may increase as the performance deteriorates.

Such disadvantage may occur not only for the disk drive device but also for other types of rotating devices.

The present invention addresses these disadvantages, and a general purpose of one embodiment of the present invention is to provide a technique for manufacturing a rotating device that can reduce the amount of carbon hydride adhering to a component of the rotating device.

An embodiment of the present invention relates to a method for manufacturing a rotating device. This manufacturing method is a method for manufacturing a rotating device comprising a hub on which a recording disk is to be mounted and a base rotatably supporting the hub. At least one of the base and the hub is an item of manufacture. The method comprises the steps of: forming the item of manufacture; immersing the formed item of manufacture in an aqueous solution, the solute of which being a surfactant and the temperature of which being higher than the melting point of heptacosane; taking out the item of manufacture from the aqueous solution and immersing the item of manufacture in a liquid that can be regarded as pure water; taking out the item of manufacture from the liquid and drying the item of manufacture; assembling the rotating device using the dried item of manufacture.

Optional combinations of the aforementioned constituting elements and implementations of the invention in the form of methods, apparatuses, or systems may also be practiced as additional modes of the present invention.

### BRIEF DESCRIPTION OF THE DRAWINGS

Embodiments will now be described, byway of example only, with reference to the accompanying drawings, which are meant to be exemplary, not limiting, and wherein like elements are numbered alike in several figures, in which:

FIG. 1A and FIG. 1B are a top view and a side view, respectively, of a rotating device manufactured by a manufacturing method according to an embodiment;

FIG. 2 is a section view sectioned along the A-A line in FIG. 1A; and

FIG. 3 is a flowchart showing the steps of manufacturing the hub.

### DETAILED DESCRIPTION OF THE INVENTION

The invention will now be described by reference to the preferred embodiments. This does not intend to limit the scope of the present invention but to exemplify the invention. The size of the component in each figure may be changed in order to aid understanding. Some of the components in each figure may be omitted if they are not important for explanation.

For example, in a related art process for forming a hub, raw materials of the hub are processed by cutting work, with the cutting oil adhering to the processed hub being washed away by detergent at an ordinary temperature. The present inventors investigated a related art technique in terms of the amount of carbon hydride remaining on surface of items of manufacture that have been formed and further washed. The present inventors have found that, among the various types of carbon hydride, there was a more prominent amount of carbon hydride remaining with a carbon number of 22 or greater. The reason for this may be the following. Since the melting point of carbon hydride of a carbon number less than 22 is at or below an ordinary room temperature, such type of carbon hydride can be effectively washed away. On the other hand, since the melting point of carbon hydride with a carbon number of 22 or greater is relatively high, it may be difficult to remove such type of carbon hydride from an item of manufacture to be washed.

To cope with this, in the manufacturing method according to the embodiment, components of a rotating device are washed with a detergent at a temperature higher than the melting point of heptacosane. This can effectively remove from the components of the rotating device carbon hydride of a carbon number 22 or greater. As a result, the amount of carbon hydride that can migrate over time to the magnetic recording disk can be suppressed.

(The Rotating Device)

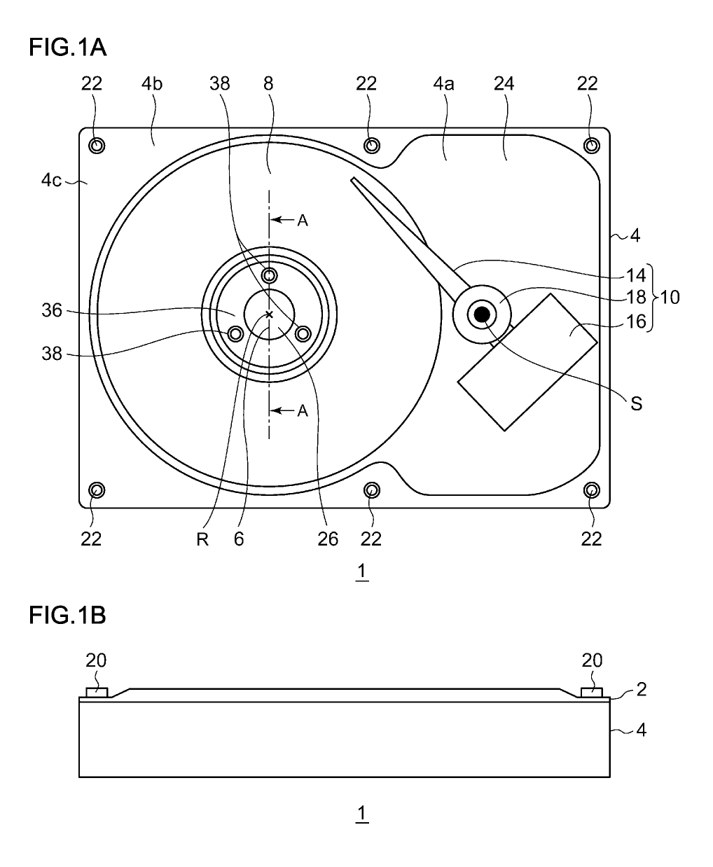

FIG. 1A and FIG. 1B are a top view and a side view, respectively, of the rotating device 1 manufactured by the manufacturing method according to an embodiment. FIG. 1A is the top view of the rotating device 1. In FIG. 1A, the rotating device 1 is shown without a top cover 2 so as to show the inside of the rotating device 1. The rotating device 1 comprises: a base 4; a rotor 6; a magnetic recording disk 8; a data read/write unit 10; and the top cover 2. The rotating device 1 is a hard disk drive that rotates the magnetic recording disk 8.

Hereinafter, it is assumed that the side of the base 4 on which the rotor 6 is installed is the “upper” side.

The magnetic recording disk 8 is a 2.5-inch type glass magnetic recording disk, the diameter of which being 65 mm. The diameter of the central hole of the magnetic recording disk 8 is 20 mm, and the thickness of the disk 8 is 0.65 mm.

The magnetic recording disk 8 is mounted on the rotor 6 and rotates with the rotor 6. The rotor 6 is rotatably mounted to the base 4 through the bearing unit 12, which is not shown in FIG. 1A.

The base 4 is produced by die-casting an alloy of aluminum. The base 4 includes: a bottom plate 4a forming the bottom portion of the rotating device 1; and an outer circumference wall 4b formed along the outer circumference of the bottom plate 4a so that the outer circumference wall 4b surrounds an installation region of the magnetic recording disk 8. Six screw holes 22 are formed on the upper surface 4c of the outer circumference wall 4b.

The data read/write unit 10 includes: a read/write head (not shown); a swing arm 14; a voice coil motor 16; and a pivot assembly 18. The read/write head is attached to the tip of the swing arm 14. The read/write head records data onto and reads out data from the magnetic recording disk 8. The pivot assembly 18 swingably supports the swing arm 14 with respect to the base 4 around the head rotation axis S. The voice coil motor 16 swings the swing arm 14 around the head rotation axis S and moves the read/write head to the desired position on the upper surface of the magnetic recording disk 8. The voice coil motor 16 and the pivot assembly 18 are constructed using a known technique for controlling the position of the head.

FIG. 1B is the side view of the rotating device 1. The top cover 2 is fixed onto the upper surface 4c of the outer circumference wall 4b of the base 4 using six screws 20. The six screws 20 correspond to the six screw holes 22, respectively. In particular, the top cover 2 and the upper surface 4c of the outer circumference wall 4b are fixed together so that the joint portion between both does not create a leak into the inside of the rotating device 1. The inside of the rotating device 1, for example, is a clean space 24 surrounded by the bottom plate 4a of the base 4 and the outer circumference wall 4b of the base 4 and the top cover 2. This clean space 24 is designed so that the clean space 24 is sealed, in other words, there is neither leakage from the outside or to the outside. The clean space 24 is filled with clean gas, with particles removed.

In the rotating device 1 manufactured by the manufacturing method according to the embodiment, there is little amount of carbon hydride that adheres to a component, such as the base 4 or the hub 28. The typical amount of carbon hydride that adheres to the component can range from 500 ng/unit to 1000 ng/unit, and sometimes the amount can reach 100 ng/unit. In particular, the amount of paraffin series carbon hydride (i.e., alkane with its carbon number being 20 or more) that adheres to the component can be suppressed to about 250 ng/unit. Therefore, each component of the rotating device 1 is considerably clean; thereby, the amount of carbon hydride that migrates, over time, from such component to the surface of the magnetic recording disk 8 is lowered. As a result, the operational reliability of the rotating device 1 can be improved, and the lifetime of the rotating device 1 can be lengthened.

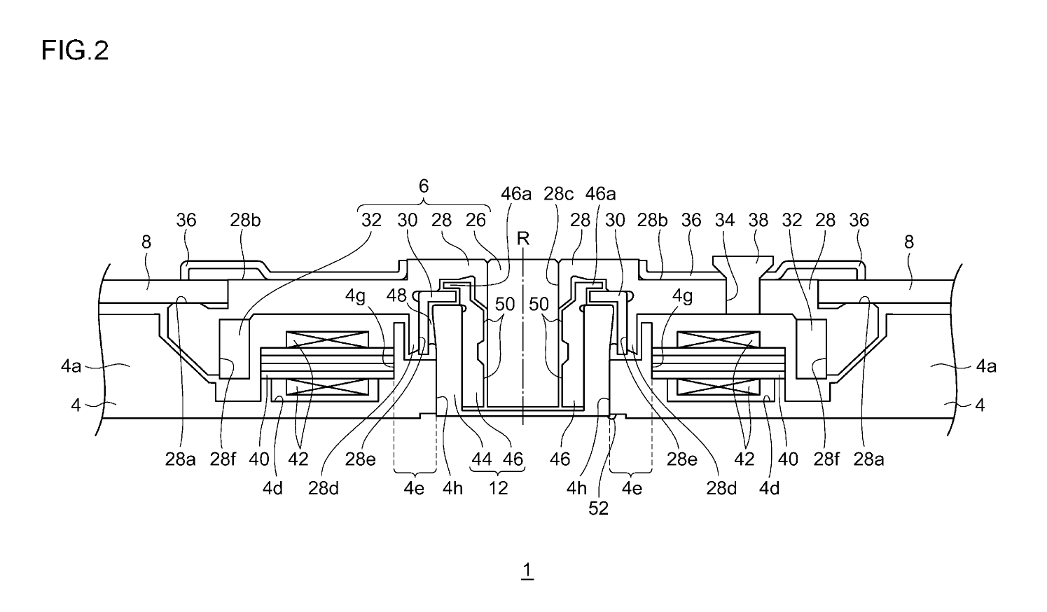

FIG. 2 is a view that is sectioned along the line A-A, as illustrated in FIG. 1A. The rotating device 1 further comprises a laminated core 40 and coils 42. The laminated core 40 is fixed on the upper surface 4d side of the base 4 and has a ring portion and twelve teeth, which extend radially outwardly from the ring portion, i.e., in a direction perpendicular to the rotational axis R. The laminated core 40 is formed by laminating four thin magnetic steel sheets and mechanically integrating them. An insulation coating is applied onto the surface of the laminated core 40 by electrodeposition coating or powder coating. Each of the coils 42 is wound around one of the twelve teeth, respectively. A driving flux is generated along the teeth by applying a three-phase sinusoidal driving current through the coils 42. A ring-shaped wall 4e, the center of which being along the rotational axis R of the rotor 6, is formed on the upper surface 4d of the base 4. The laminated core 40 is fitted to the outer surface 4g of the ring-shaped wall 4e with a press-fit or clearance fit and glued thereon.

A through hole 4h, the center of which being along the rotational axis R of the rotor 6, is formed on the base 4. The bearing unit 12 includes the housing 44 and the sleeve 46 and rotatably supports the rotor 6 with respect to the base 4. The housing 44 is glued in the through hole 4h of the base 4. The housing 44 is formed to be cup-shaped by integrating a cylindrical portion and a bottom portion as a single unit. The housing 44 is glued to the base 4 with the bottom portion downside.

Around the lower edge of the through hole 4h, a thermosetting conductive resin 52 is applied so that the resin is over the base 4 and the housing 44.

The cylindrical sleeve 46 is glued on the inner side surface of the housing 44. A jetty portion 46a, which radially outwardly juts out, is formed at the upper end of the sleeve 46. This jetty portion 46a, in cooperation with the flange 30, limits the motion of the rotor 6 in the direction along the rotational axis R.

The sleeve 46 accommodates the shaft 26. The lubricant 48 is injected into a region in between part of the rotor (the shaft 26, the flange 30, and the hub 28) and the bearing unit 12.

A pair of herringbone-shaped radial dynamic pressure generation grooves 50, which are vertically separated from each other, are formed on the inner surface of the sleeve 46. The first herringbone-shaped thrust dynamic pressure grooves (not shown) are formed on the lower surface of the flange 30 that faces the upper surface of the housing 44. The second herringbone-shaped thrust dynamic pressure grooves (not shown) are formed on the upper surface of the flange 30 that faces the lower surface of the jetty portion 46a. The rotor 6 is axially and radially supported by the dynamic pressure generated in the lubricant 48 by these dynamic pressure grooves when the rotor 6 rotates.

The pair of herringbone-shaped radial dynamic pressure generation grooves may be formed on the shaft 26. The first thrust dynamic pressure generation grooves can be formed on the upper surface of the housing 44, and the second thrust dynamic pressure generation grooves may be formed on the lower surface of the jetty portion 46a.

The rotor 6 includes the shaft 26, the hub 28, the flange 30 and a cylindrical magnet 32. The magnetic recording disk 8 is mounted on a disk-mount surface 28a of the hub 28. Three screw holes 34 for affixing a disk are arranged on the upper surface 28b of the hub 28 at 120-degree intervals around the rotational axis R of the rotor 6. The clamper 36 is pressed against the upper surface 28b of the hub 28 by three screws 38 for affixing a disk, which are screwed in the corresponding three screw holes 34 for affixing a disk. The clamper 36 presses the magnetic recording disk 8 against the disk-mount surface 28a of the hub 28.

The hub 28 is formed to be predetermined cup-like shape by cutting wrought aluminum.

The shaft 26 is fixed in the hole 28c arranged at the center of the hub 28 by using both press-fitting and glue, the hole 28c being arranged coaxially with the rotational axis R of the rotor 6. The flange 30 is in ring-shape and has a reverse L-shaped cross section. The flange 30 is glued on an inner surface 28e of a hanging portion 28d of the hub 28.

The cylindrical magnet 32 is glued on a cylindrical inner surface 28f, which is an inner cylindrical surface of the cup-like hub 28. The cylindrical magnet 32 is made of a rare-earth material such as Neodymium, Iron, or Boron. The cylindrical magnet 32 faces radially towards the twelve teeth of the laminated core 40. The cylindrical magnet 32 is magnetized for driving, with sixteen poles along the circumferential direction (i.e., in a tangential direction of a circle the center of which being in the rotational axis R, the circle being perpendicular to the rotational axis R). The surface of the cylindrical magnet 32 is treated for preventing rusting by electro deposition coating or spray coating.

In the after-mentioned manufacturing method, at least one of the base 4 and the hub 28 is immersed and washed in an aqueous solution, the solute of which being a surfactant and the temperature of which being higher than the melting point of heptacosane. This washing can effectively remove the type of carbon hydride of a carbon number of 22 or greater, such as heptacosane, from these components.

(The Manufacturing Method)

The manufacturing method according to the embodiment is a method for manufacturing a rotating device. The rotating device is, for example, a disk drive device. In particular, the rotating device is a hard disk drive that includes a magnetic recording disk. In what follows, the case where the above-mentioned rotating device 1 is manufactured is described as one example.

The manufacturing method according to the embodiment comprises the steps of making each component of the rotating device 1, assembling the rotating device 1 by combining the components made, and inspecting the appearance, the operation or the function of the assembled rotating device 1. The step of assembling the rotating device 1 can be arranged using a known art of assembling. The step of inspecting can be arranged using a known art of inspection.

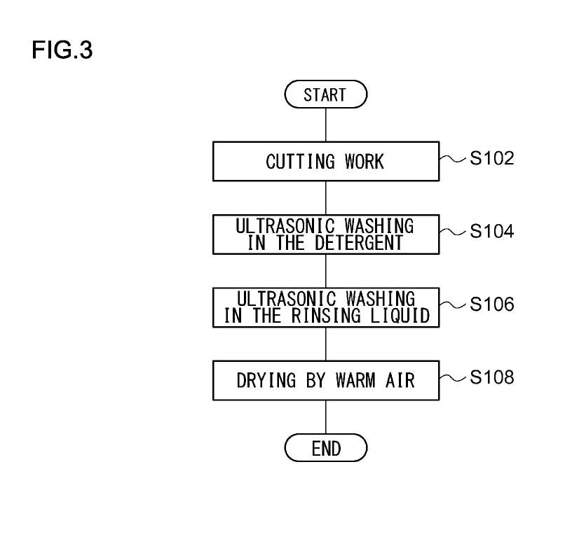

FIG. 3 is a flowchart showing the steps of manufacturing the hub 28. The manufacturing steps start with a step S102 of forming the hub 28 to be a predetermined shape by cutting wrought aluminum, which is raw material of the hub 28. During the cutting to form an item of manufacture, a cutting agent such as a cutting oil is used. The cutting agent includes a large amount of carbon hydride. Therefore, a large amount of carbon hydride adheres to the hub 28 that has been processed by cutting.

The next step S104 is a step of immersing the formed hub 28 in a detergent at a temperature ranging from the melting point of heptacosane, or 58 degrees Celsius, to the melting point of tetratetracontane, or 85 degrees Celsius, and performing ultrasonic washing with the detergent. In the ultrasonic washing, an ultrasonic vibration is applied to the detergent in which the hub 28 has been immersed. This detergent is an aqueous solution, the solute of which being substantially a surfactant. Accordingly, a large amount of carbon hydride can be removed from the surface of the hub 28.

The pH (or hydrogen ion exponent) of the detergent ranges from 2 to 4 when the hub 28 is immersed in the detergent during the step of the ultrasonic washing. For example, a detergent of this particular pH balance may be provided by adding an organic acid, such as a citric acid, to a commercially-available detergent. The concentration of the citric acid is to be less than 40 percent and is preferably around 30 percent. If the concentration of the citric acid is less than 10 percent, the after-mentioned tarnish-suppression effect may be difficult to obtain. Since it generally is easier to handle an organic acid than an inorganic acid, organic acid is preferred in light of handling. In addition, organic acid is preferred in light of cost since citric acid is relatively inexpensive.

The next step S106 is a step of taking the hub 28 out of the detergent, immersing the hub 28 thus taken out in a rinsing liquid, and performing ultrasonic washing in the rinsing liquid. Accordingly, a large amount of detergent or carbon hydride can be removed from the surface of the hub 28. The rinsing liquid is a liquid that can be regarded as pure water. In particular, the rinsing liquid may contain detergent or carbon hydride originating from the previously-rinsed hub 28, so that the effect of the rinsing liquid does not notably deteriorate.

The temperature of the rinsing liquid when the hub 28 is immersed in the rinsing liquid during the step of ultrasonic washing in the rinsing liquid is to be lower than the temperature of the detergent when the hub 28 is immersed in the detergent during the step of ultrasonic washing in the detergent. For example, the temperature of the rinsing liquid ranges from 20 degrees Celsius to 35 degrees Celsius.

The next step S108 is a step of taking the hub 28 out of the rinsing liquid and drying the hub 28 thus taken out using warm air. Alternatively, natural drying or vacuum drying may be used. The dried hub 28 is used in the step of assembling the rotating device 1.

Other components, including the base 4, are manufactured according to similar processes of forming, washing, and drying. When the base 4 is manufactured, the base 4 is produced by die-casting an alloy of aluminum. The surface of the formed base 4 is coated with epoxy resin, etc. A leak test is performed with respect to the coated base 4.

A base 4 processed in such a way is carbon-hydride contaminated with grease that can adhered to a device during die-casting or from cutting oil used for component trimming. Alternatively, since an elastic resin such as the coating of the base 4 or the portion of the leak test tool that touches an item of manufacture includes carbon hydride, it is possible for carbon hydride to migrate to the base 4 through contact between such resin and the base 4. However, similar to the hub 28, washing the item of manufacture with the detergent can remove such carbon hydride.

In the manufacturing method according to the present embodiment, before assembling the rotating device 1, it is possible to reduce the amount of carbon hydride that adheres to each component. In particular, a detergent can be used in the washing step at a temperature higher than the melting point of heptacosane. The aforementioned facilitates the removal of carbon hydride of a carbon number greater than or equal to 22. This is because, since the melting point of carbon hydride, in particular alkane, increases as the carbon number increases, the efficiency of removal of carbon hydride with large carbon number increases as the temperature of the detergent increases. The following first chart shows typical alkane with the name and the melting point.

### [First Chart]

| CARBON | | MELTING |
|---|---|---|
| NUMBER | NAME | POINT (° C.) |
| 12 | DODECANE | −9.5 |
| 14 | TETRADECANE | 6 |
| 16 | HEXADECANE | 18 |
| 18 | OCTADECANE | 28 |
| 20 | EICOSANE | 37 |
| 22 | DOCOSANE | 44 |
| 24 | TETRACOSANE | 52 |
| 26 | HEXACOSANE | 56 |
| 27 | HEPTACOSANE | 58 |
| 28 | OCTACOSANE | 64 |
| 30 | TRIACONTANE | 66 |
| 32 | DOTRIACONTANE | 69 |
| 36 | HEXATRIACONTANE | 74 |
| 40 | TETRACONTANE | 82 |
| 44 | TETRATETRACONTANE | 85 |
| 50 | PENTACONTANE | 91 |
| 60 | HEXACONTANE | 96 |

The present inventors performed several washings with detergent at different temperatures. For each washing, the amount of carbon hydride remaining on the surface of the hub 28 was measured after the hub 28 had been washed and dried, with the carbon hydride under measurement ranging from a carbon number of 22 to a carbon number of 44. The following second chart shows the results of the measurements. In this chart, the amount of remaining carbon hydride is evaluated with a five-grade evaluation, where “1” indicates that most of the carbon hydride remains, “3” indicates that carbon hydride is partially removed, and “5” indicates that most of carbon hydride is removed.

### [Second Chart]

| SAMPLE | A | B | C | D | E | F |
|---|---|---|---|---|---|---|
| TEMPERATURE | 30° | 40° | 50° | 60° | 70° | 85° |
| OF DETERGENT | C. | C. | C. | C. | C. | C. |
| TEMPERATURE OF | 30° | 30° | 30° | 30° | 30° | 30° |
| RINSING LIQUID | C. | C. | C. | C. | C. | C. |
| AMOUNT OF REMAINING | 2 | 2 | 3 | 5 | 5 | 5 |
| CARBON HYDRIDE | | | | | | |

According to these results of the measurements, it can be seen that carbon hydride with a carbon number from 22 to 44 can effectively be removed by raising the temperature of the detergent to that over the melting point of heptacosane.

In general, in order to miniaturize a rotating device or to increase the capacity of the rotating device, one option is to arrange a magnetic head to be closer to the surface of a magnetic recording disk, thereby reducing the width of a recording track and increasing the memory density. However, as the distance between the magnetic head and the magnetic recording disk decreases, the effect of carbon hydride adhering to the magnetic head or the magnetic recording disk becomes greater. To cope with this, in the manufacturing method according to the present embodiment, it is possible to effectively reduce the amount of carbon hydride adhering to each component of the rotating device 1. In particular, it is possible to effectively reduce the amount of carbon hydride of a carbon number ranging from 22 to 44, which had been difficult to remove using techniques of the related art. Therefore, it becomes possible to reduce the amount of carbon hydride migrating to the magnetic recording disk over time. As a result, the lifetime of the rotating device can be lengthened. Alternatively, the rotating device can be miniaturized or the capacity of the rotating device can be increased. Alternatively, all of the above may be realized.

In the manufacturing method according to the present embodiment, a detergent at a temperature lower than the melting point of tetratetracontane is used for the washing step. Therefore, it is possible to reduce the amount of vapors emerging from a washing container while facilitating the removal of carbon hydride of a carbon number ranging from 22 to 44. This will contribute to keeping the factory environment in good condition. In the case where the carbon number exceeds, for example, 44, the melting point of the carbon hydride becomes sufficiently high. As a result, the migration of the carbon hydride from the components of the rotating device 1 to the surface of the magnetic recording disk 8 can be suppressed. Therefore, realistically, even if carbon hydride of a carbon number more than 44 remains on the components of the rotating device, such carbon hydride will not significantly affect the operation of the rotating device.

In the case where the temperature of the detergent is relatively high, it is a concern that the surface of the component to be washed, such as the hub 28, may tarnish due to washing. One of the reasons why such tarnishing happens may be because the chemical reaction between the metal used for the component to be washed and alkaline component in the detergent creates hydroxide. For example, in the case where the component to be washed is made of an aluminum alloy, the surface of the component to be washed chemically reacts with the alkaline component in the detergent during washing. Such reaction creates aluminum hydroxide. Since aluminum hydroxide is hardly-soluble to neutral or alkaline water, such aluminum hydroxide remains on the surface of the component to be washed. Since aluminum hydroxide performs a blackening reaction with metal ions in the detergent, such aluminum hydroxide causes the component to tarnish. This blackening reaction proceeds faster as the temperature of the detergent becomes higher. Therefore, if the temperature of the detergent is high, there may be significant tarnishing on the surface of the component to be washed.

To cope with this, in the manufacturing method according to the present embodiment, an acid detergent is used. This can suppress the tarnishing of the surface due to washing. In the detergent made acidic by adding acid, the hydroxylation of metal used for the component to be washed can be suppressed. In addition, even if hydroxide is created, such hydroxide is easy to dissolve in the acid detergent and easy to be removed from the surface of the component to be washed. As a result, the tarnishing of the surface of the component to be washed is suppressed even if the temperature of the detergent is made high.

According to experiments performed by the present inventors, suppression of the tarnishing was found for the case where the pH of the detergent was less than 6. In addition, it was found that the tarnishing was reduced to a practically usable level for the case where the pH of the detergent was less than 4. It should be noted that, in the case where the pH of the detergent is less than 2, such detergent may harm production facilities. For example, the lifetime of the washing container may be shortened. Therefore, in the present embodiment, the pH of the detergent ranges preferably from 2 to 4.

The present inventors performed several washings with rinsing liquids of different temperatures. They measured the amount of carbon hydride remaining on the surface of the hub 28 after the hub 28 had been washed and dried, where the carbon number of the carbon hydride under measurement ranged from 22 to 44. The following third chart shows the results of measurements. In this chart, the amount of remaining carbon hydride is evaluated with a five-grade evaluation, as in the second chart.

### [Third Chart]

| SAMPLE | G | H | I | J | K | L |
|---|---|---|---|---|---|---|
| TEMPERATURE | 60° | 60° | 60° | 60° | 60° | 60° |
| OF DETERGENT | C. | C. | C. | C. | C. | C. |
| TEMPERATURE OF | 15° | 20° | 35° | 45° | 60° | 85° |
| RINSING LIQUID | C. | C. | C. | C. | C. | C. |
| AMOUNT OF REMAINING | 5 | 5 | 5 | 4 | 4 | 3 |
| CARBON HYDRIDE | | | | | | |

According to these results of the measurements, it was found that carbon hydride could be at least partially removed at least when the temperature of the rinsing liquid ranged from 15 degrees Celsius to 85 degrees Celsius. However, it was found that the function of removing carbon hydride was weakened if the temperature of the rinsing liquid was 45 degrees Celsius or higher and that it took a longer time to reduce the amount of remaining carbon hydride to a desired amount or below. One exemplary reason of this may be the following. As the temperature of the rinsing liquid becomes higher, the effect of cavitations due to ultrasonic wave decreases. Therefore, the rinsing with a liquid at a lower temperature is preferred. In the manufacturing method according to the present embodiment, the temperature of the rinsing liquid is lower than the temperature of the detergent.

In general, in order to keep the temperature of the rinsing liquid at 15 degrees Celsius or lower, it is necessary to construct a cooling facility. This is disadvantageous in light of available factory space, cost for construction, or labor. Therefore, the rinsing liquid at a temperature ranging from 20 degrees Celsius to 35 degrees Celsius is preferred.

Above is an explanation for the method for manufacturing the rotating device according to the embodiment. This embodiment is intended to be illustrative only, and it will be obvious to those skilled in the art that various modifications to constituting elements and processes could be developed and that such modifications are also within the scope of the present invention.

The embodiment describes the case where the manufactured rotating device 1 is the hard disk drive. However, the present invention is not limited to this, and the manufactured rotating device is not limited to the hard disk drive. For example, the technical aspects according to the embodiment can be applied to a method for manufacturing arbitrary rotating devices, the components of which being necessary to be washed in order to remove carbon hydride in the manufacturing process.

The embodiment describes the case where the hub 28 is formed by cutting an item of manufacturing. However, the present invention is not limited to this. For example, the hub 28 may be formed by press-working. In this case, the carbon hydride adhering to the press-worked device may migrate to the formed hub 28. Therefore, by performing a washing step similar to that of the embodiment, it is possible to remove such carbon hydride adhering to the hub 28.

The embodiment describes the case where the ultrasonic washing is performed in the detergent and in the rinsing liquid. However, the present invention is not limited to this. For example, instead of the ultrasonic washing in the detergent, micro-bubble washing may be utilized in which bubbles, the diameter of which being less than or equal to 30 μm, are emitted into the detergent in which the hub 28 is immersed. The similar idea applies to the ultrasonic washing in the rinsing liquid. In this case, it is less likely for the hub 28 to be damaged in the washing process.

The embodiment describes the case where the acid detergent is created by adding a citric acid. However, the present invention is not limited to this. For example, various types of know acids can be added to make the detergent acidic.

The embodiment describes the case where, after the hub 28 is formed by cutting, the hub 28 alone is washed. However, the present invention is not limited to this. For example, a step of mounting the cylindrical magnet 32 to the hub 28 formed by cutting may be arranged between the step of cutting the hub 28 and the step of performing ultrasonic washing of the hub 28 in the detergent. In this case, the hub 28 to which the cylindrical magnet 32 is mounted is immersed in the detergent and ultrasonic-washed during the step of ultrasonic washing in the detergent. According to this modification, excess glue or grease that may adhere to the hub 28 or the cylindrical magnet 32 when the cylindrical magnet 32 is mounted to the hub 28 can be washed away during the step of washing.

The embodiment describes the case where cutting oil used in cutting remains on the hub 28 or the base 4 and where such remaining oil becomes one of the reasons why carbon hydride adheres to the hub 28 or the base 4. However, the present invention is not limited to this. For example, carbon hydride adhering to production facilities such as tools used for the manufacturing process or assembling process may migrate to the hub 28 or the base 4. Alternatively, carbon hydride may migrate to the hub 28 or the base 4 originating from operators who perform such processes. The technical aspects according to the embodiment can be used in order to remove such carbon hydride from the hub 28 or the base 4.

Cross-contamination is explained below. If extraneous material adheres to an object, the extraneous material may migrate to the production facilities of the object. Afterward, if another object touches the production facilities, the extraneous material that had adhered to the production facilities may re-migrate to another object. In this manner, while processing many objects, extraneous material that had adhered to one object may migrate to another object through the production facilities. This is called cross-contamination.

In the case where the cylindrical magnet 32 is glued on the hub 28 after the hub 28 is washed and dried, there is a concern that glue or grease may adhere to the hub 28 or the cylindrical magnet 32 through of the handling of operators or through the production facilities during the step of gluing the cylindrical magnet 32. In addition, there is a concern that glue or grease may adhere to the hub 28 or the cylindrical magnet 32 due to cross-contamination, e.g., through the production facilities for gluing. In the manufacturing method according to this modification, since the step of washing the hub 28 is performed after the cylindrical magnet 32 is mounted to the hub 28, it is possible for the washing step to reduce the amount of glue or grease that adheres during the step of gluing or to reduce the amount of glue or grease due to cross-contamination.

The similar idea applies to the base 4 and the laminated core 40. In that, a step of mounting the laminated core 40 to the base 4 formed by die-casting may be arranged between the step of die-casting of the base 4 and the step of performing ultrasonic washing in the detergent. In this case, the base 4 to which the laminated core 40 is mounted can be immersed in the detergent and ultrasonic-washed during the step of ultrasonic washing in the detergent.

What is claimed is:

1. A method for manufacturing a rotating device comprising a hub on which a recording disk is to be mounted and a base rotatably supporting the hub, at least one of the base and the hub being an item of manufacture, the method comprising the steps of:
forming the item of manufacture;
immersing the formed item of manufacture in an aqueous solution, the solute of which being a surfactant and the temperature of which being higher than the melting point of heptacosane;
taking out the item of manufacture from the aqueous solution and immersing the item of manufacture in a liquid that can be regarded as pure water;
taking out the item of manufacture from the liquid and drying the item of manufacture; and
assembling the rotating device using the dried item of manufacture.

2. The method according to claim 1, wherein, in the step of immersing in the aqueous solution, the aqueous solution's pH when the item of manufacture is immersed ranges from 2 to 4.

3. The method according to claim 2, wherein the aqueous solution for immersion includes an organic acid.

4. The method according to claim 3, wherein the organic acid is citric acid.

5. The method according to claim 1, further comprising the step of mounting a magnet to the formed item of manufacture in the case where the item of manufacture is the hub, wherein
the step of immersing the item of manufacture in the aqueous solution involves immersing, in the aqueous solution, the hub to which the magnet has been mounted.

6. The method according to claim 1, further comprising the step of mounting a core to the formed item of manufacture in the case where the item of manufacture is the base, wherein
the step of immersing the item of manufacture in the aqueous solution involves immersing, in the aqueous solution, the base to which the core has been mounted.

7. The method according to claim 1, further comprising the step of applying an ultrasonic vibration to the aqueous solution in which the item of manufacture has been immersed or to the liquid in which the item of manufacture has been immersed.

8. The method according to claim 1, further comprising the step of emitting bubbles, the diameter of which being less than or equal to 30 μm, into the aqueous solution in which the item of manufacture has been immersed or into the liquid in which the item of manufacture has been immersed.

9. The method according to claim 1, wherein, in the step of immersing the item of manufacture in the aqueous solution, the temperature of the aqueous solution when the item of manufacture is immersed is lower than the melting point of tetratetracontane.

10. The method according to claim 1, wherein, in the step of immersing the item of manufacture in the liquid, the temperature of the liquid when the item of manufacture is immersed is lower than the temperature of the aqueous solution into which the item of manufacture had been immersed in the step of immersing the item of manufacture in the aqueous solution.

11. A method for manufacturing a rotating device comprising a hub on which a recording disk is to be mounted and a base rotatably supporting the hub, at least one of the base and the hub being an item of manufacture, the method comprising the steps of:
forming the item of manufacture;
immersing the formed item of manufacture in an acid aqueous solution, the temperature of which being higher than the melting point of heptacosane;
taking out the item of manufacture from the aqueous solution and immersing the item of manufacture in a liquid that can be regarded as pure water;
taking out the item of manufacture from the liquid and drying the item of manufacture; and
assembling the rotating device using the dried item of manufacture.

12. The method according to claim 11, wherein, in the step of immersing the item of manufacture in the aqueous solution, the aqueous solution's pH when the item of manufacture is immersed ranges from 2 to 4.

13. The method according to claim 12, wherein the aqueous solution for immersion includes an organic acid.

14. The method according to claim 13, wherein the organic acid is citric acid.

15. The method according to claim 11, further comprising the step of mounting a magnet to the formed item of manufacture in the case where the item of manufacture is the hub, wherein
the step of immersing the item of manufacture in the aqueous solution involves immersing, in the aqueous solution, the hub to which the magnet has been mounted.

16. The method according to claim 11, further comprising the step of mounting a core to the formed item of manufacture in the case where the item of manufacture is the base, wherein
the step of immersing the item of manufacture in the aqueous solution involves immersing, in the aqueous solution, the base to which the core has been mounted.

17. The method according to claim 11, further comprising the step of applying an ultrasonic vibration to the aqueous solution in which the item of manufacture has been immersed or to the liquid in which the item of manufacture has been immersed.

18. The method according to claim 11, further comprising the step of emitting bubbles, the diameter of which being less than or equal to 30 μm, into the aqueous solution in which the item of manufacture has been immersed or into the liquid in which the item of manufacture has been immersed.

19. The method according to claim 11, wherein, in the step of immersing the item of manufacture in the aqueous solution, the temperature of the aqueous solution when the item of manufacture is immersed is lower than the melting point of tetratetracontane.

20. The method according to claim 11, wherein, in the step of immersing the item of manufacture in the liquid, the temperature of the liquid when the item of manufacture is immersed is lower than the temperature of the aqueous solution into which the item of manufacture had been immersed in the step of immersing the item of manufacture in the aqueous solution.
